(19) United States
(12) Patent Application Publication
(10) Pub. No.: US 2019/0278669 A1
(43) Pub. Date: Sep. 12, 2019

(54) METHOD FOR RESTORE AND BACKUP OF APPLICATION CONTAINERS IN A SHARED FILE SYSTEM

(71) Applicant: INTERNATIONAL BUSINESS MACHINES CORPORATION, ARMONK, NY (US)

(72) Inventors: Dominic Mueller-Wicke, Weilburg (DE); Nils Haustein, Soergenloch (DE)

(21) Appl. No.: 15/912,626

(22) Filed: Mar. 6, 2018

(51) Int. Cl. G06F 11/14; G06F 3/06; G06F 17/30

(52) U.S. Cl. CPC G06F 11/1469; G06F 11/1451; G06F 17/30165; G06F 3/0622; G06F 3/0664; G06F 11/1464

(57) ABSTRACT

The present disclosure relates to a backup-restore system being configured for: receiving a data processing request from a backup-restore client, BRC, of a container, the request indicating second file attributes of data to be processed, where the second file attributes are configured to enable access to data files by the container. The system is further configured for determining first file attributes corresponding to the second file attributes, where the first file attributes are configured to control access to data file by a shared file system. The system is further configured for sending the request to a backup client of the storage system, the sent data request indicating the second file attributes of the data to be processed; thereby causing the backup client to process the request on the local storage and/or backup storage.

### BACKGROUND

The present invention relates to the field of digital computer systems, and more specifically, to a method for processing data files in a storage system having containers.

A shared file system is a system on which many compute nodes can access the same data or applications over a network. A compute node may provide networking, memory, processing resources, and transitory storage, which may be consumed by a virtual machine instance. The compute nodes may include a plurality of application containers running on the compute nodes. An example of a container is a Docker container. Docker is a trademark or a registered trademark of Docker, Inc. The containers may be used to virtualize an operating system for applications. Each container is a tenant to the share file system. The containers store their data in the shared file system whereby each container has its own directory within the shared file system. Each container can see only its own directory from the shared file system, but not the directory of other containers.

Virtualization allows the computer server to contain multiple hosts or virtual machines, where each virtual machine or host can be accessed remotely by the user over the internet. The host may appear to be an independent computer server by use of virtualization. The host may have one or more containers. A container is a set of processes isolated from other parts of the computer server, and other hosts. A container can encapsulate an application and its dependency.

The containers store their data in the shared file system whereby each container has its own directory within the shared file system. Each container can see only its own directory from the shared file system, but not the directory of other containers.

The path name in the shared file system is translated to the path name within the container—which can be different from the shared file system path—by a container-shared-filesystem driver.

One advantage of having a plurality of application containers running on a plurality of cluster nodes to store their data in a shared file system is the centralized backup function within the shared file system. Instead of running 1000s of backup jobs within the container it is much more efficient to run one backup job within the shared file system to backup all container data.

Each application container is a tenant to the share file system. From the container perspective, it can only see its own data which is stored in a directory of the shared file system. The backup and restore function of the shared file system however is not aware of containers, it just sees the file system with different directories. In summary, the backup and restore function within a shared file system is not multi-tenant aware.

The backup and restore function of the shared file system however is not aware of containers; it just sees the file system with different directories. This may pose a security risk because from the file system perspective a container could access data from another container during the restore process.

### SUMMARY

According to an embodiment, a method, computer system, and computer program product for processing data files in a storage system, backup-restore proxy, and computer program product is provided. Embodiments of the present invention may be combined if they are not mutually exclusive.

The present invention may include a method for processing data files in a storage system including at least one compute node and a shared file system, the data files being stored in at least one of a local storage of the shared file system and a backup storage, the shared file system controlling access to the data files using first file attributes of the data files, where at least one container is executable on the compute node, the container including a container file system enabling access to a portion of the data files in the shared file system assigned to the container using second file attributes of the portion of the data files. The method includes providing the container with a container backup-restore client, (hereinafter “BRC”), and providing at least one backup-restore proxy, (hereinafter “BRP”), receiving by one of the provided BRP a data processing request from the BRC, the received request indicating second file attributes of data of the portion of data files to be processed, upon the receiving, sending by the BRP the request (the sent request by the BRP may be obtained from the received data processing request by e.g. adding or deleting information in the data processing request) to a backup client of the storage system, the sent request indicating the first file attributes of the data to be processed, thereby causing the backup client to process the request on at least one of the local storage and backup storage. The backup client is part of the compute node that includes the BRP from which the request is received. Data files being in the shared file system means that the data files are stored in the local storage to which the access is controlled by the shared file system.

In another embodiment, the invention relates to a computer program product comprising a computer-readable storage medium having computer-readable program code embodied therewith, the computer-readable program code configured to implement all of steps of the method according to preceding embodiments.

In another embodiment, the invention relates to a backup-restore system. The backup-restore system is configured for being configured for: receiving a data processing request from a backup-restore client, BRC of a container, the request indicating second file attributes of data to be processed, where the second file attributes are configured to enable access to data files by the container, determining first file attributes corresponding to the second file attributes, where the first file attributes are configured to control access to data file by a shared file system, sending the request to a backup client of the storage system, the sent data request indicating the second file attributes of the data to be processed, thereby causing the backup client to process the request on the local storage and/or backup storage.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram of a storage system, according to an embodiment;

FIG. 2 is a flowchart of a method for processing data files in the storage system, according to an embodiment;

FIG. 3 is a sequence diagram of a method for performing a backup for a container, according to an embodiment;

FIG. 4 is a sequence diagram of a method for performing a backup query for a container, according to an embodiment;

FIG. 5 is a sequence diagram of a method for performing a restore of backed up data for a container, according to an embodiment;

FIG. 6 is a block diagram of internal and external components of computers and servers, according to an embodiment;

FIG. 7 depicts a cloud computing environment according to an embodiment; and

FIG. 8 depicts abstraction model layers according to an embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to a method for processing data files in a storage system having containers. The following described exemplary embodiments provide a system, method, and program product to, among other things, for processing data files in a storage system, a backup-restore proxy, and replacing data files in the storage system from the backup-restore proxy. Therefore, the present embodiment has the capacity to improve the technical field of digital computer systems by improving liability and isolating container backups.

According to an embodiment, a container aware backup system that allows each container to query, backup and restore its data, but not other data. The container aware backup system includes a novel container backup-restore client that manages backup, query and restore for the container. The novel container aware backup-restore client can be a thick client (installed in the container) or a thin client (e.g. web application with a web server running on the underlying compute-storage nodes). This novel container backup-restore client requests operations from a novel backup-restore proxy that is installed on the compute nodes running containers. The novel backup-restore proxy gets the container path translated into shared file system path and requests operation from the prior art shared file system backup client. This assures that that container can only access its data from the shared file system even during a restore. The translation of the container path to the file system path is done by a prior art container-filesystem adapter. The prior art shared file system backup client executes the operation with the backup server and returns the results to the novel backup-restore proxy that returns the results to the novel container backup-restore client. With this method, each container is treated as tenant who can only see its data, providing multi-tenant backup and restore capabilities in a shared file system. In addition, this invention leverages the central backup functions that is much more scalable than other prior art techniques.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to create a container aware backup system.

A storage system may include a backup client-server configuration. The client-server configuration may include a backup client in each compute node of at least part of the compute nodes of the storage system. The client-server configuration may further include a backup server that control access to data stored on the backup storage. The causing of the backup client to process the data processing request on the local storage via the shared file system and/or backup storage may involve communication with and/or operation of the backup server in order to process the data processing request.

The storage system in accordance with the present disclosure may be a container aware backup system that treats each container as a tenant, where the tenant can query, backup and restore its data, but not other data of other containers. This may enable a backup and restore function within a shared file system which renders the shared file system multi-tenant aware. The present disclosure provides a tenant aware backup and restore by bridging the backup and restore between the container and the shared file system. The bridging may be achieved by a backup-restore client that is installed within each container of the storage system that needs to be backed up. And at least part of the compute nodes of the storage system having containers are each enhanced with a backup-restore proxy (BRP). In addition, the present disclosure leverages the central backup functions of a shared file system that may be more scalable than other prior art techniques. The BRP that receives the request from the BRC may be an available BRP of the provided BRPs. The available BRP may or may not be part of the compute node of the BRC that sends the request. This is because the BRP of the compute node of the BRC is not available (e.g. due to a failure) or because the compute node of the BRC does not include a BRP.

The term “container” or “application container” refers to a software package. The software package may be self-contained or standalone package. The software package contains a piece of software such as an application in a complete container having codes, a runtime environment, system tools, system libraries, or other suitable components sufficient to execute the piece of software. Containers running on a single server or virtual machine can all share the same operating system kernel and can make efficient use of system or virtual memory. A container can include an application and all of its dependencies, but shares an operating system kernel with other containers on the same host. As such, containers can be more resource efficient and flexible than virtual machines. Containerized software or application may run in the same way, regardless of the environment. Containers isolate software from its surroundings and may thus help reduce conflicts between teams running different software on the same infrastructure. Containers may run on a server or virtual machine. One example container runtime is a Docker. A characteristic of application containers is that the usage may have very limited time frame and that they can be moved easily from one node to another without functional impact if the data used in the container is available on the new node. The container may include resources such as CPU, RAM, file system and applications. Multiple containers running on a same server can store their data using the same file system provided by the server via a container-filesystem adapter. The adapter allows the container to access the underlying file system and translates the container path into file system path. For example, each container of the compute nodes of the storage system has access to its directories and files but cannot access directories and files from other containers. In another example, a configuration of containers may be provided. The configuration may allow to share common data between at least part of the application containers of the compute nodes of the storage system.

The term “user” refers to an entity e.g., an individual, a computer, or an application executing on a computer, a container, a file system, a directory. The user may for example represent a group of users.

The term “compute node” refers to a computing system including one or more processors and memory.

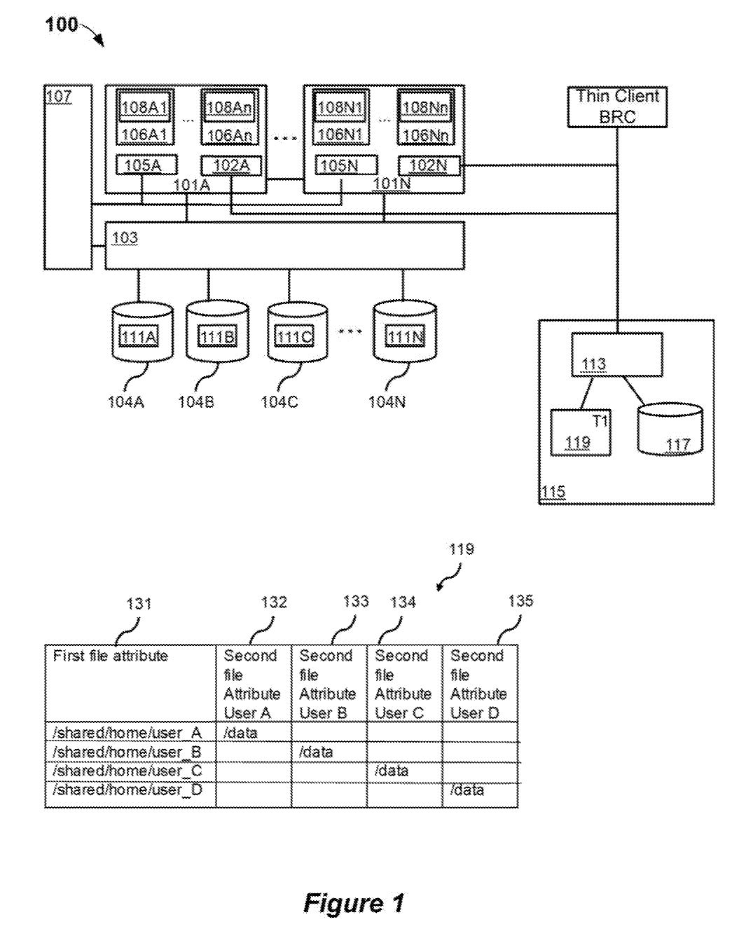

Referring to FIG. 1, a block diagram of a storage system 100 is depicted, according to an embodiment. The storage system 100 may provide a compute storage cluster architecture with a backup system.

The storage system 100 may include a set of one or more compute nodes 101A-N with a shared file system 103. In the shared file system each compute node of the set of one or more compute nodes 101A-N can access the same file system regardless of its physical location. The set of one or more compute nodes 101A-N are connected to the shared file system 103 via a network. The shared file system 103 may be connected via a network to shared local disk storages 104A-N and may use the shared local disk storages 104A-N to store data. The data stored may be stored as files, where a file is a sequence of bytes. The shared file system 103 may be configured to access data files 111A-N in the local storages 104A-N using first file attributes. A file attribute may refer to at least one of a file and a path name, an active retention policy, and a reference to a backup storage 117 where the backup copy of a file is stored and the file type.

The set of one or more compute nodes 101A-N may each include a corresponding backup client 102A-N. The backup clients 102A-N may be a shared file system. Each of the shared file system backup clients 102A-N may have access to the complete file system content (e.g. an access to each of the data files managed by the shared file system 103) of the shared file system 103. The shared file system backup clients 102A-N may be connected to a backup-restore server 113. The backup-restore server 113 may be configured to run on a server system 115 and may be connected to the backup storage 117 via a network to store backup data. The backup-restore server 113 may maintain a data structure 119. The data structure 119 may be a table T1. The data structure 119 may represent the inventory of backup data including metadata for backed up files of the shared file system 103. The metadata may include first file attributes.

Backup processing at the storage system 100 may include scanning the data files 111A-N of the shared file system 103 being stored on the local storages 104A-N, comparing the scan results with inventory data stored in the data structure 119 of the backup-restore server 113, identifying the differences and processing the differences. Processing the differences may include sending new or changed data of the shared file system 103 to the backup-restore server 113, updating the inventory table T1 with the data of the shared file system 103 with changed attributes and deleting content from the backup-restore server 113, from the data structure 119 and from the backup storage 117, if the content of the shared file system 103 was deleted.

Respective sets of one or more containers 106A1-An, 106B1-Bn . . . 106N1-Nn may run on a respective compute node of the set of one or more compute nodes 101A-N. For example, the compute node 101A may include a set of one or more containers 106A1-An. The set of one or more containers 106A1-Nn may be configured to use the shared file system 103 for storing their data. Each of the containers of the set of one or more containers 106A1-Nn may include a container file system that manages the data of the respective container using second file attributes of the data.

The storage system 100 may include a container-filesystem adapter 107. The container-filesystem 107 may be configured to provide each container of the set of one or more containers 106A1-Nn a name space (e.g. directory) at the shared file system 103. The set of one or more container containers 106A1-Nn may be connected to the shared file system 103 via the container-filesystem 107, where each container of the set of one or more containers 106A1-Nn has, for example, its own directory within the shared file system 103. An example for an container-filesystem 107 is Ubiquity™ (Ubiquity™ is a registered trademark of Ubiquity Networks) that provides the set of one or more containers 106A1-Nn access to the shared file system 103. An example of a shared file system 103 is an IBM Spectrum Scale™ (IBM Spectrum Scale™ is a registered trademark of IBM Corp.) shared file system. With the container-filesystem 107, a container of the set of one or more containers 106A1-Nn may store its data in the shared file system 103 (storing data in the shared file system means storing data in the shared local disk storage 104A-N that are managed by the shared file system). Each container of the set of one or more containers 106A1-Nn may be configured to access its own data only. For this purpose, each container of the set of one or more containers 106A1-Nn may use a dedicated directory in the shared file system 103 that is not accessible by another container of the set of one or more containers 106A1-Nn. The container-filesystem 107 may map the first file attributes of the shared file system 103 to the second file attributes used within the set of one or more containers 106A1-Nn. Thus, each container of the set of one or more containers 106A1-Nn may be tenant of the shared file system 103. This may enable the multi-tenancy's feature on the shared file system 103.

An example content of the data structure 119 is shown in FIG. 1. The data structure 119 may be a table depicting the data view from two perspectives, the shared file system and the container file system.

Table 119 includes a column 131 for the first file attribute used by the shared file system 103. Columns 132-135 include values of the second file attribute used by different containers of respective users A-D. In this example of table 119, the file attribute being used is the path or directory where a file is stored by the respective file system. For example, the second row indicates that the data for a container of user A can be accessed by the shared file system 103 in the directory named “/shared/home/user_A ”, while the container file system may access the same data using the local directory in the container which is named “/data”. Container of user A can only access data in its directory.

At least part of the data structure 119 may be stored in the backup-restore server 113. The at least part of the data structure 119 may, for example, indicate data files being stored in the backup storage 117. The mapping provided by the data structure 119 may be a unique mapping.

The container-filesystem adapter 107 may provide access for the containers of the sets of one or more containers 106A1-An to the shared file system 103. The data structure 119 may be stored at or accessible by the container-filesystem adapter 107. For example, since the container path is different from the shared file system 103 path, the container-filesystem adapter 107 may use the mapping between the container path to the file system path of the data structure 119. The container-filesystem 107 may include a path translation application programming interface, (hereinafter “API”) which may map between the first and second file attributes.

To facilitate container aware backup and restore maintaining multi-tenancy for the containers of the set of one or more containers 106A1-Nn, the storage system 100 may provide two types of components, a backup-restore proxy, (hereinafter “BRP”) and a backup-restore client, (hereinafter “BRC”). Each container of the set of one or more containers 106A1-Nn may include a respective BRC of a set one or more BRC 108A1-Nn. Each compute node of at least part of the set of one or more compute nodes 101A-N may include a respective BRP of a set of one or more BRP 105A-N. For example, compute node 101C may not include a BRP. A BRP may or may not be available. For example, if the BRP cannot run e.g. because of a failure or a bug, the BRP may be unavailable.

The set of one or more BRC 108A1-Nn may be configured to use an API provided from an available BRP of the set of one or more BRP 105A-N to get information relevant for backup and restore activity, for example, path translation. The set of one or more BRC 108A1-Nn may be configured to communicate with the set of one or more BRP 105A-N by means of TCP/IP port and IP address, and the BRP of the set of one or more BRP 105A-N may not run on each compute node of the set of one or more compute nodes 101A-N. The API may include configuration information for the set of one or more BRC 108A1-Nn indicating how to communicate with a BRP of the set of one or more BRP 105A-N. The set of one or more BRC may further have access to a list of BRPs of the set of one or more BRP 105A-N and may communicate with a BRP of the listed set of one or more BRP 105A-N. This may enable flexibility and high availability in case a BRP of the set of one or more BRP 105A-N fails.

In an embodiment, for BRC 108C1 of compute node 101C, the available BRP of the set of one or more BRP 105A-N may be an available BRP of the set of one or more BRP 105A-N of another compute node of the set of one or more compute nodes 101A-N of the storage system 100 such as BRP 105A.

In an embodiment, the BRC 108A1 may use the BRP 105A of the same compute node 101A if the BRP 105A is available. However, if the BRP 105A is not available, the BRC 108A1 may use an available BRP of the set of one or more BRP 105A-N of another compute node of the storage system 100 such as BRP 105B. The BRP 105A-N uses the path translation API of the container-filesystem adapter 107 that for example translates the container path (columns 132-134) into the shared file system path (column 131). Furthermore, the BRP 105A-N may use the API of the backup and restore client 102A-N to get backup file information (e.g. stored in the data structure 119) and to initiate backup and restore activity.

A BRC of the BRCs 108A1-Nn may be a thick client (installed in the container) or a thin client (e.g. web client application).

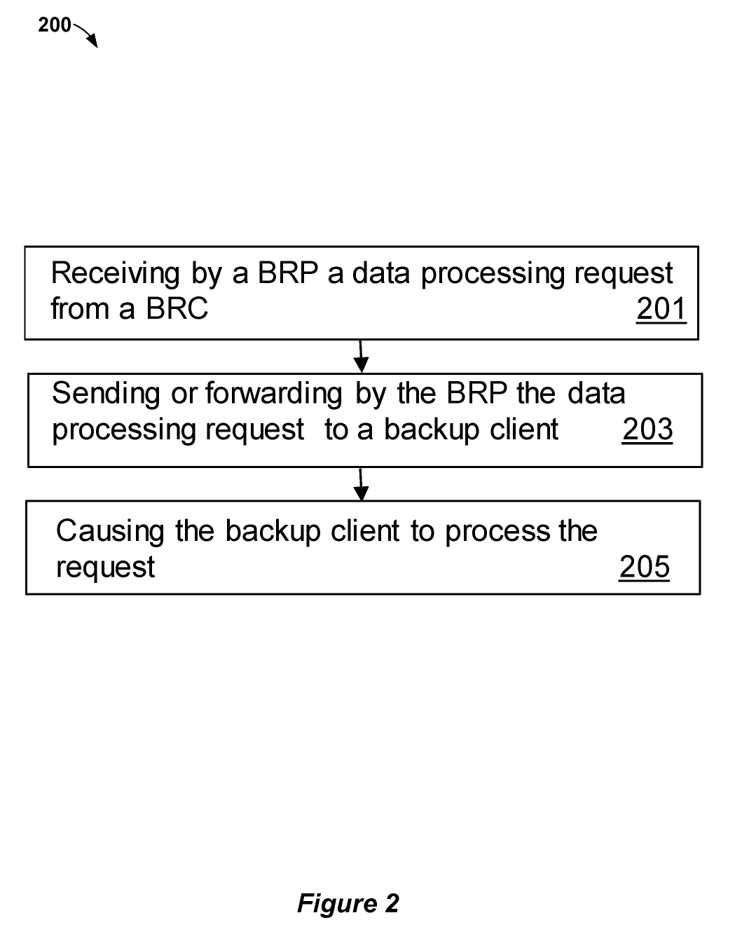

Referring to FIG. 2, a flowchart of a method 200 for processing data files (e.g. files 111A-C) in storage system 100 is depicted, according to an embodiment.

At step 201, a BRP of the set of one or more BRP 105A-N may receive a data processing request from a BRC from the set of one or more BRC 108A1-Nn.

In an embodiment, the BRP 108A1 may receive a data processing request from the BRP 105A. The BRC 108A1 in the container 106A1 which sends the data processing request may belong to the same compute node 101A of the BRP 105A.

In an embodiment, the BRC 108A1 may be configured to access the files 111A-C of the respective container 106A1. The received data processing request may include the second file attributes of one or more data files of the data files 111A-C that can be accessed by the BRC 108A1 in the container 106A. For example, the data processing request may include the second file attributes of the two data files 111A-B such that the files 111A-B may be processed. The second file attributes of the files 111A-B may be defined by the container file system of the container 106A1 running the BRC 108A1. For example, the second file attributes of files 111A-B may include the path and file names “/data/fileA” and “/data/fileB”, respectively.

The data processing request may be a read request for reading the files 111A-B, write request for storing files 111A-B, backup request for backing up the files 111A-B from the local storage 104A to the backup storage 117, restore request to restore the files 111A-B from the backup storage 117, or an update request to update the content of the files 111A-B using the files 111A-B of the request.

Next, at step 203, a BRP of the set of one or more BRP 105A-N may send (or forward) the data processing request to a backup client of the backup clients 102A-N.

In an embodiment, the BRP 105A may send (or forward) the data processing request to the backup client 102A of the compute node 101A of the BRP 105A. The data processing request from the BRC 108A1 may be configured such that the sent request, by the BRP 105A, may include the first file attributes of the files 111A-B. The sent request by the BRP 105A may or may not further include the second file attributes of the files 111A-B.

Then, at step 205, the sent request may result in a backup client of the backup clients 102A-N to process the request on at least one of the shared local disk storage 104A-N and the backup storage 117.

In an embodiment, the backup client 102A may process the request on at least one of the local storage 104A-N and backup storage 117. The first file attributes of files 111A-B may include the path and file names of the shared file system 103: “/shared/home/userA1/fileA” and “/shared/home/userA1/fileB”, respectively.

The first file attributes may, for example, be obtained by the BRP 105A upon receiving the data processing request from the BRC 108A1. In an example, the BRP 105A may use the data structure 119 for identifying or determining the first file attributes that map to the second file attributes of files 111A-B. In another example, the BRP 105A may use the data structure 119 for identifying or determining the second file attributes that map to the first file attributes of files 111A-B.

In another example, the BRP 105A may send a translation request to the container-filesystem 107 in order to request the first file attributes that correspond to the second file attributes of the files 111A-B.

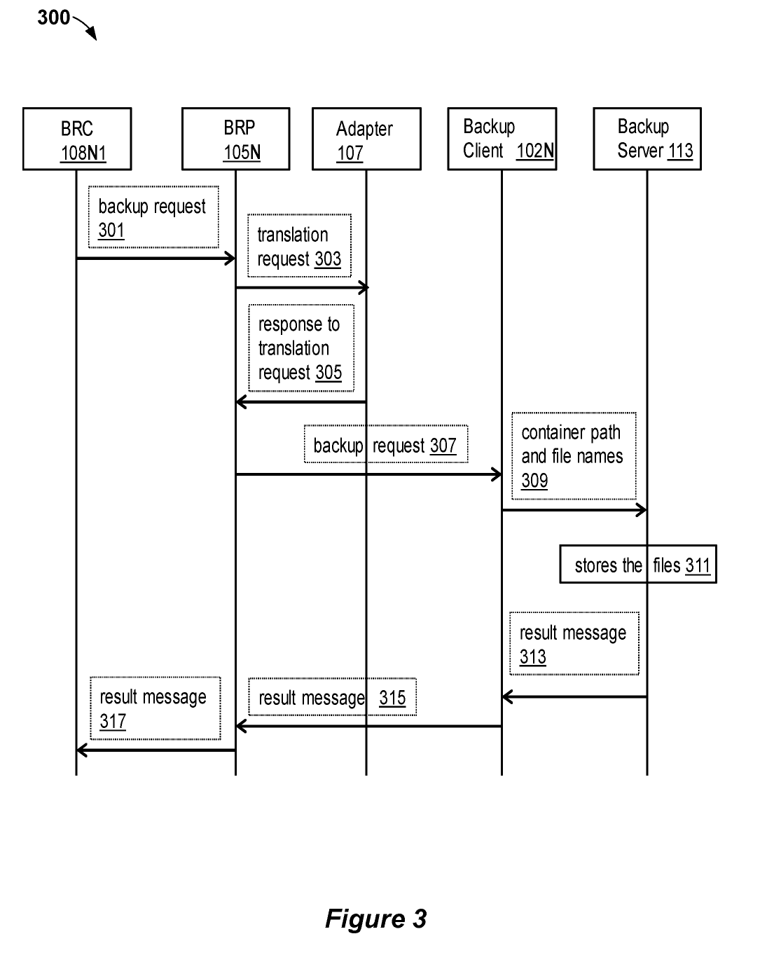

Referring to FIG. 3, a sequence diagram 300 of a method for performing the backup for data of a container 106A1-Nn exemplifying the execution of the method 200 is depicted, according to an embodiment. For exemplification purpose, the BRC 108N1 is used as the source of the backup request. The container 106N1 (e.g. of user N1) of the BRC 108N1 may have access to the respective data files 111K-N.

At step 301, the BRC 108N1 of container 106N1 running on the compute node 101N sends a backup request to the respective BRP 105N including the container path and file name of files to be backed up of the files 111K-N. The container path and file name are the second file attributes. For example, the files to be backed up are files 111M-N.

In an embodiment, a user in container 106N1 may initiate a backup of the files 111M-N by using an interface provided from the BRC 108N1. The interface may be a web-based graphical user interface (GUI) or a command line interface (CLI).

At step 303, the BRP 105N sends a translation request to the container-filesystem adapter 107 including the container path and file name to be backed up of the received backup request.

At step 305, the container-filesystem adapter 107 returns to the BRP 105N the shared file system path and file names that can be mapped to the container path and file names of the files 111M-N. The shared file system path and file names are the first file attributes of the files 111M-N.

At step 307, the BRP 105N sends a backup request to the shared file system backup client 102N of the compute node 101N including the shared file system path and file names and the associated container path and file name.

At step 309, the shared file system backup client 102N backs up the files 111M-N denoted by the shared file system path and file names to the backup-restore server 113 and sends the container path and file names to the backup-restore server 113.

At step 311, the backup-restore server 113 stores the files 111M-N and updates the data structure 119 with the file system path and file name and the container path and file name of the files 111M-N (in an internal repository of the backup-restore server 113).

For example, the backup-restore server 113 may have the following information in the data structure 119:

| First file attribute | Second file attribute | File name |
|---|---|---|
| /shared/home/user_N1/ | /data/ | fileM |
| /shared/home/user_N1/ | /data/ | fileN |

At step 313, the backup-restore server 113 sends a result message to the file system backup client 102N.

At step 315, the file system backup client 102N sends the received result message to the BRP 105N.

At step 317, the BRP 105N sends the result message to the BRC 108N1.

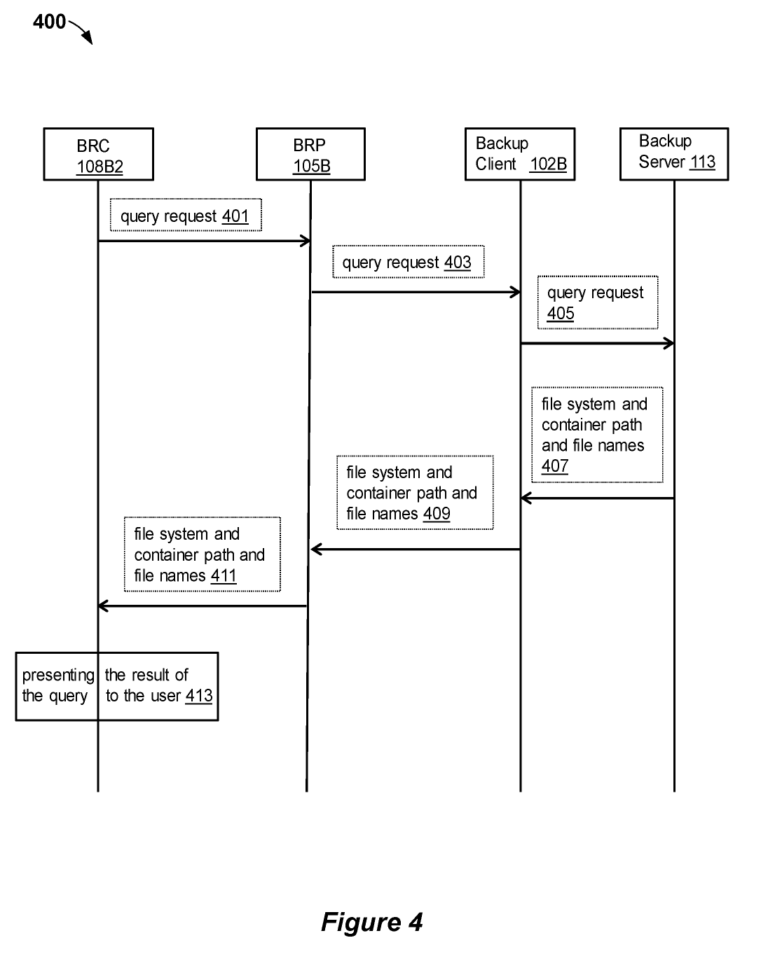

Referring to FIG. 4, a sequence diagram 400 of a method for performing the backup query for a container 106A1-Nn exemplifying the execution of the method 200 is depicted, according to an embodiment. For exemplification purpose, the BRC 108B2 is used as the source of the backup query. The container 106B2 of the BRC 108B2 may have access to the data files 111D-H.

At step 401, the BRC 108B2 sends a query request to the respective BRP 105B including the second file attributes including the container path and file name of the files to be queried. For examples, the files to be queried are files 111D-H.

At step 403, the BRP 105B sends a query request to the corresponding shared file system backup client 102B of the compute node 101B including the container path and file name of the files 111D-H.

At step 405, the shared file system backup client 102B sends a query to the backup-restore server 113 to get both the file system path and file names (first file attributes) and the container path and file names of the files 111D-H to be queried.

At step 407, the backup-restore server 113 sends the file system (first file attribute) and container path and file names (second file attribute) back to the shared file system backup client 102B.

At step 409, the shared file system backup client 102B sends the file information to the BRP 105B.

At step 411, the BRP 105B sends that information to the BRC 108B2.

At step 413, the BRC 108B2 presents the result of the query to the user. The user may be a user in the container 108B2.

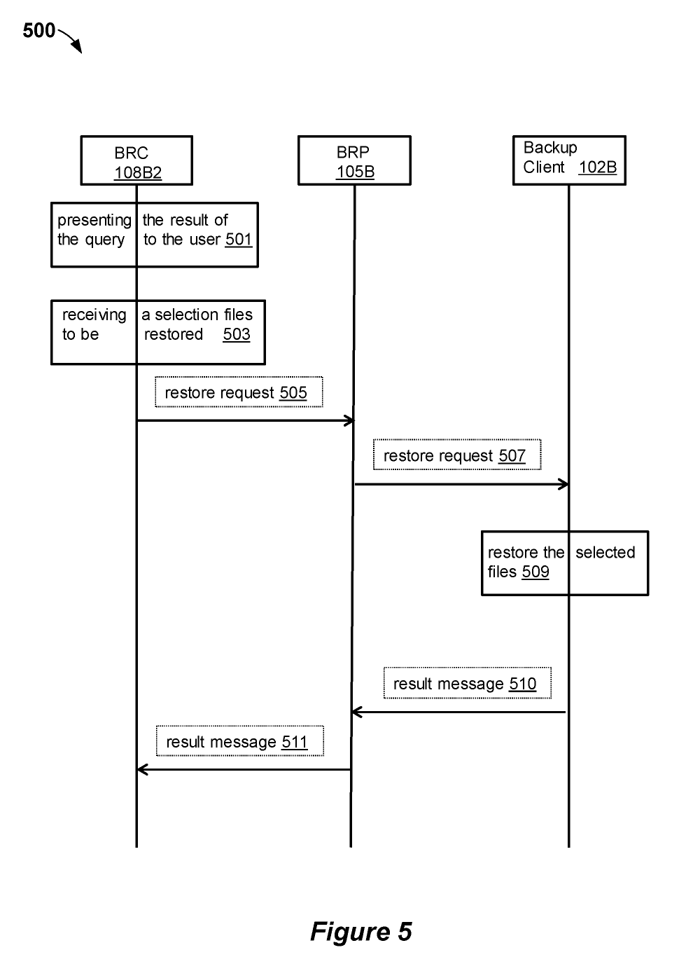

Referring to FIG. 5, a sequence diagram 500 of a method for performing the restore of backed up data for a container 106A1-Nn exemplifying the execution of the method 200 is depicted, according to an embodiment. For exemplification purpose, the BRC 108B2 is used as the source of the restore query. Following the above example, the container 106B2 of the BRC 108B2 has access only to the respective data files 111D-H.

At step 501, the BRC 108B2 performs a backup query for files 111D-H and presents the list of available files in the backup server to the user in container 106B2. The files presented to the user are denoted by the second file attributes (e.g. container path and file name) and optionally by the first file attributes (e.g. shared file system path and file name).

At step 503, the BRC 108B2 receives from the user a selection of the files to be restored, e.g. the user may select files 111G-H to be restored. For example, the user marks the files to be restored (e.g. clicking on check mark). The user may initiate the restore of the marked files (e.g. hit on restore button in GUI).

At step 505, BRC 108B2 sends a restore request to the corresponding BRP 105B of compute node 101B, including the container (second file attribute) and the file system path and file name (first file attribute) of the files 111G-H to be restored.

At step 507, the BRP 105B sends a restore request to the associated shared file system backup client 102B including the shared file system path and file names (first file attribute) of the files 111G-H.

At step 509, the shared file system backup client 102B restores the files 111G-H denoted by shared file system path and file names and returns in step 510 a result message to the BRP 105B.

At step 511, the BRP 105B sends the result message to the BRC 106B2.

According to an embodiment, the method further includes providing a data structure for mapping the first file attributes to the corresponding second file attributes, where the sending of the request includes using the second file attributes of the data to be processed for determining the corresponding first file attributes in the data structure. This embodiment may further enhance the function of the storage system with the data structure that allows for example to store both the path name of a file from the shared file system and the path name of the file inside the container. The data structure includes entries for each of the containers of the set of one or more containers 106A1-nn and thus may provide an efficient mean for a central entity (e.g. the shared file system 103) to limit data access of a given container to data of the given container only. The access is limited by the fact that a given container only has access to second file attributes of the files that it can access and not the second attributes of other containers.

According to an embodiment, the data structure includes first file attributes and corresponding second attributes of data files stored on the backup storage.

As a BRC of set of one or more BRCs 108A1-Nn is configured to communicate with a BRP of the set of one or more BRPs 105A-N of other compute nodes e.g. by means of TCP/IP port and IP address, the BRP may not have to run on each compute node. According to an embodiment, the BRP (that receives from the BRC the request and sends the request) runs on the compute node of the BRC or runs on another compute node of the at least one compute node. For example, the storage system includes multiple compute nodes, where each compute node of at least part of the multiple compute nodes includes a backup client and a provided BRP. The BRP may send the request to the backup client of the compute node of the BRP. The BRC may have access to a list of BRPs and can communicate with an available BRP the listed BRPs. This may enable flexibility and high availability in case a BRP fails.

According to an embodiment, the shared file system includes a backup client (also referred to as shared file system backup client) being configured to connect to a remote backup server, the backup server managing access to the backup storage. The backup server includes the data structure. The data structure may for example be stored on a repository of the backup server. This may assure that a given container can only access its data from the shared file system even during a restore. The data structure enables the backup server to process data access requests in dependence of the containers. This is by contrast to a method where the backup requests are treated regardless of the container sending the request.

According to an embodiment, the data processing request includes a backup request for backing up given data files from the local storage to the backup storage. The data to be processed includes the given data files. The sending by the BRP includes: determining the first file attributes of the given data files corresponding to the second file attributes. Determining the first file attributes at the BRP may improve the bridging between container file systems of the compute node and the shared file system. For example, multiple containers of the compute node may use the same BRP to trigger the translation of the second file attributes as well as the request for data.

According to an embodiment, the storage system includes an adapter. The determining of the first file attributes of the given data files includes sending by the BRP a translation request to the adapter for translating the second file attributes of the given data files and receiving the first file attributes of the given data files. For example, the BRP may get the container path of file of a given container translated into shared file system path and requests operations from the shared file system backup client using the file system path. This may assure that the given container can only access its data from the shared file system even during a restore.

According to an embodiment, the sending by the BRP includes: sending by the BRP the backup request to the backup client for controlling the backup client to backup the given data files from the local storage of the shared file system to the backup storage. The backup request includes both the first and second file attributes of the given data files. This embodiment may seamlessly be integrated with the existing backup systems having a client part for managing requests at the local or client side of the backup system.

According to an embodiment, the backup client is configured to connect to a backup server. The backup server manages access to the backup storage. The backup server includes a data structure mapping first file attributes to corresponding second attributes of data files stored on the backup storage. The controlling of the backup client includes backing up the given data files to the backup server, storing by the backup server the given data files on the backup storage, and updating the data structure to include the first file attributes and corresponding second attributes of the given data files. This embodiment may seamlessly be integrated in existing systems by making use of a client-server configuration in accordance with the present disclosure and may allow the translation of the first file attributes and the second file attributes. The update of the data structure may be advantageous because outdated information on stored data may cause data access failures.

According to an embodiment, the data processing request includes a restore request for restoring given data files from the backup storage to the local storage of the shared file system. The data to be processed includes the given data files being qualified or indicated by respective second file attributes. The sending by the BRP includes: sending the restore request indicating the first file attributes of the given data files to the backup client for controlling the backup client to restore the given data files from the backup server; receiving from the backup client a result message indicative of the restore request being successfully processed.

According to an embodiment, the method further includes obtaining the first file attributes of the given data files comprising: receiving by the BRP a query request from the BRC, the query request including second file attributes of files that can be queried; sending by BRP the query request to the backup client; thereby controlling the backup client to send the query request to a backup server comprising a data structure mapping the second file attributes to the corresponding first file attributes; receiving from the backup server first file attributes and the second file attributes, provided by means of the data structure, of the files that can be queried; sending to the BRC the first file attributes and the second file attributes of the files that can be queried, causing the BRC to present the received first and second file attributes to a user of the storage system and to receive a selection of the given data files. This embodiment may further limit the access of the container to data of the container as it may prevent an unconditional and automatic full restore of all data in the shared file system using the selection feature and the fact that the container only knows (or only has access to) its own second file attributes.

According to an embodiment, the adapter includes a data structure for translating the second file attributes. The data structure maps the first file attributes to the corresponding second file attributes.

According to an embodiment, the shared file system includes the backup client that is configured to connect to a remote backup server. The backup server manages access to the backup storage. For example, the BRP may be part of the backup client. This may enhance the function of the backup client part of the shared file system with a minimum of extra resources.

According to an embodiment, the BRC is a thin client that is configured to send the data access request as a HTTP request to the BRP. For example, the BRP may be web application with a web server running on the compute node of the BRP allowing the BRC to send HTTP requests.

According to an embodiment, the storage system includes another compute node running another container enabling access to a respective distinct other portion of the data files in the shared file system assigned to the other container using respective second file attributes of the other portion of the data files, the method further comprising: determining that at least one file of the data to be processed of the portion has a dependency with a another data file of the other portion, sending by the BRP a data processing request to another BRP of the other compute node, for controlling the other BRP to send a request to the shared file system, indicating at least one of the first and second file attribute of the other data file in order to be processed in a similar manner as the data to be processed of the portion. For example, a first container of a first compute node has a first file whose content relates to the content of a second file of a second container of a second compute node, such that a change in the content of the first file is accompanied by or implies a change of the content of the second file. In this case, upon receiving by the BRP of the first compute node a data processing request involving the first file, it detects that the second file also needs to be processed and may thus send the request as described above to the BRP of the second compute node. This may enable a consistent content of the data in the storage system in particular when each compute node includes a respective compute node.

According to an embodiment, the determining of the dependency is performed using dependency data, where the dependency data indicates at least one of: content dependency between the files of the storage system, owners of the files of the storage system. For example, two files belonging to the same owner may be determined as being dependent or having dependency to each other. The content dependency may for example indicate that two or more files are edited with the same editing conditions. E.g. if a first file is to be backed-up because it has been updated by changing the format of all listed dates in the first file, in this case files using the same date format that has changes would be identified as dependent of the first file and may be updated.

According to an embodiment, the storage system comprising another compute node running another container enabling access to a respective distinct other portion of the data files in the shared file system assigned to the other container using respective second file attributes of the other portion of the data files, the method further comprising: determining that at least one file of the data to be processed of the portion has a dependency with a another data file of the other portion controlling the BRP to send a request to the shared file system, indicating at least one of the first and second file attribute of the other data file in order to be processed in a similar manner as the data to be processed of the portion. This embodiment may particularly be advantageous in case the BRP is not bound to a specific compute node or a set of containers.

According to an embodiment, a file attribute of the first and second file attributes includes at least one of a respective file path, file type and file name.

It may be appreciated that FIGS. 2-5 provides only an illustration of one implementation and does not imply any limitations with regard to how different embodiments may be implemented. Many modifications to the depicted environments may be made based on design and implementation requirements.

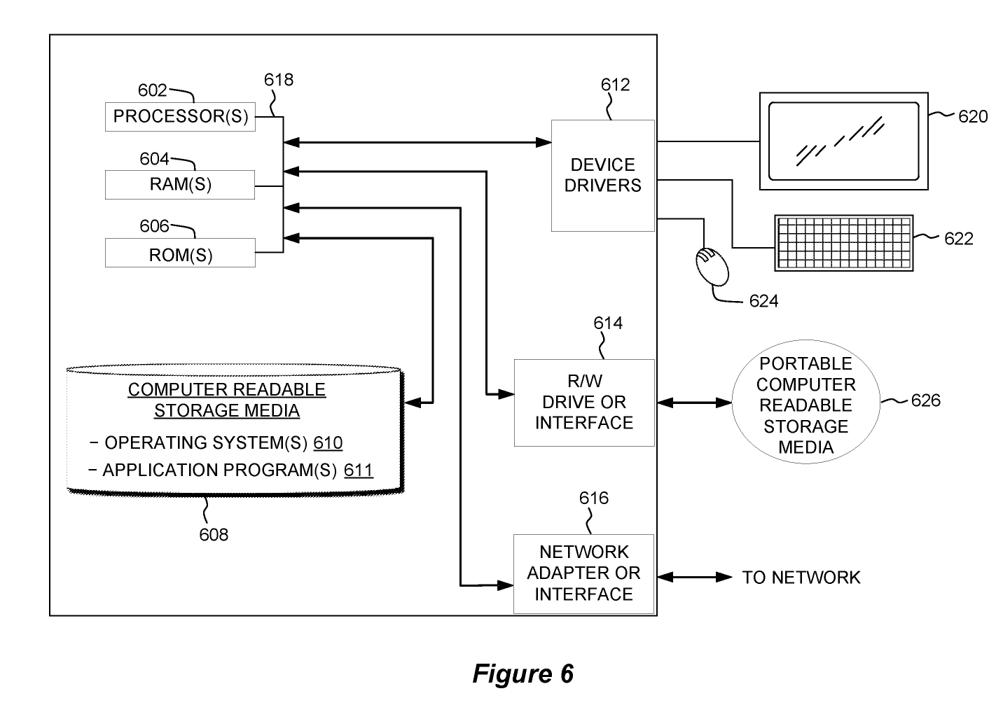

Referring now to FIG. 6, a block diagram of components of a computing device and a server which may be used in accordance with an embodiment of the present invention. It should be appreciated that FIG. 6 provides only an illustration of one implementation and does not imply any limitations with regard to the environments in which different embodiments may be implemented. Many modifications to the depicted environment may be made.

The computing device may include one or more processors 602, one or more computer-readable RAMs 604, one or more computer-readable ROMs 606, one or more computer readable storage media 608, device drivers 612, read/write drive or interface 614, network adapter or interface 616, all interconnected over a communications fabric 618. Communications fabric 618 may be implemented with any architecture designed for passing data and/or control information between processors (such as microprocessors, communications and network processors, etc.), system memory, peripheral devices, and any other hardware components within a system.

One or more operating systems 610, and one or more application programs 611, for example, the method 200 for processing data files, are stored on one or more of the computer readable storage media 608 for execution by one or more of the processors 602 via one or more of the respective RAMs 604 (which typically include cache memory). In the illustrated embodiment, each of the computer readable storage media 608 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computing device may also include a R/W drive or interface 614 to read from and write to one or more portable computer readable storage media 626. Application programs 611 on the computing device may be stored on one or more of the portable computer readable storage media 626, read via the respective R/W drive or interface 614 and loaded into the respective computer readable storage media 608.

The computing device may also include a network adapter or interface 616, such as a TCP/IP adapter card or wireless communication adapter (such as a 4G wireless communication adapter using OFDMA technology). Application programs 611 on the computing device may be downloaded to the computing device from an external computer or external storage device via a network (for example, the Internet, a local area network or other wide area network or wireless network) and network adapter or interface 616. From the network adapter or interface 616, the programs may be loaded onto computer readable storage media 608. The network may include copper wires, optical fibers, wireless transmission, routers, firewalls, switches, gateway computers and/or edge servers.

The computing device may also include a display screen 620, a keyboard or keypad 622, and a computer mouse or touchpad 624. Device drivers 612 interface to display screen 420 for imaging, to keyboard or keypad 422, to computer mouse or touchpad 424, and/or to display screen 620 for pressure sensing of alphanumeric character entry and user selections. The device drivers 612, R/W drive or interface 614 and network adapter or interface 616 may include hardware and software (stored on computer readable storage media 608 and/or ROM 606).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

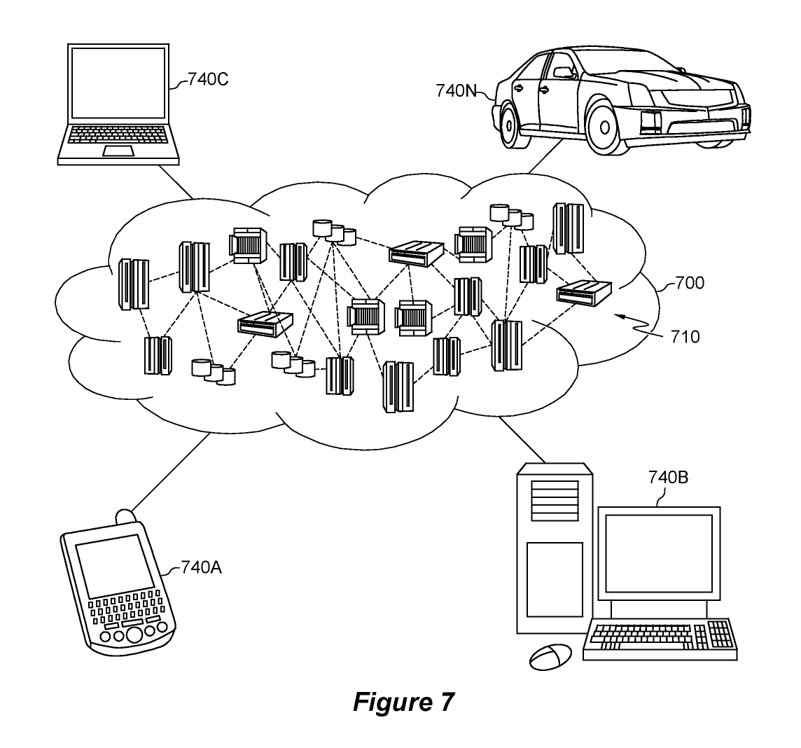

Referring now to FIG. 7, illustrative cloud computing environment 700 is depicted. As shown, cloud computing environment 700 includes one or more cloud computing nodes 710 with which local computing devices used by cloud consumers, such as, for example, personal digital assistant (PDA) or cellular telephone 740A, desktop computer 740B, laptop computer 740C, and/or automobile computer system 740N may communicate. Nodes 700 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 740A-N shown in FIG. 7 are intended to be illustrative only and that computing nodes 710 and cloud computing environment 700 can communicate with any type of computerized device over any type of network and/or network addressable connection (e.g., using a web browser).

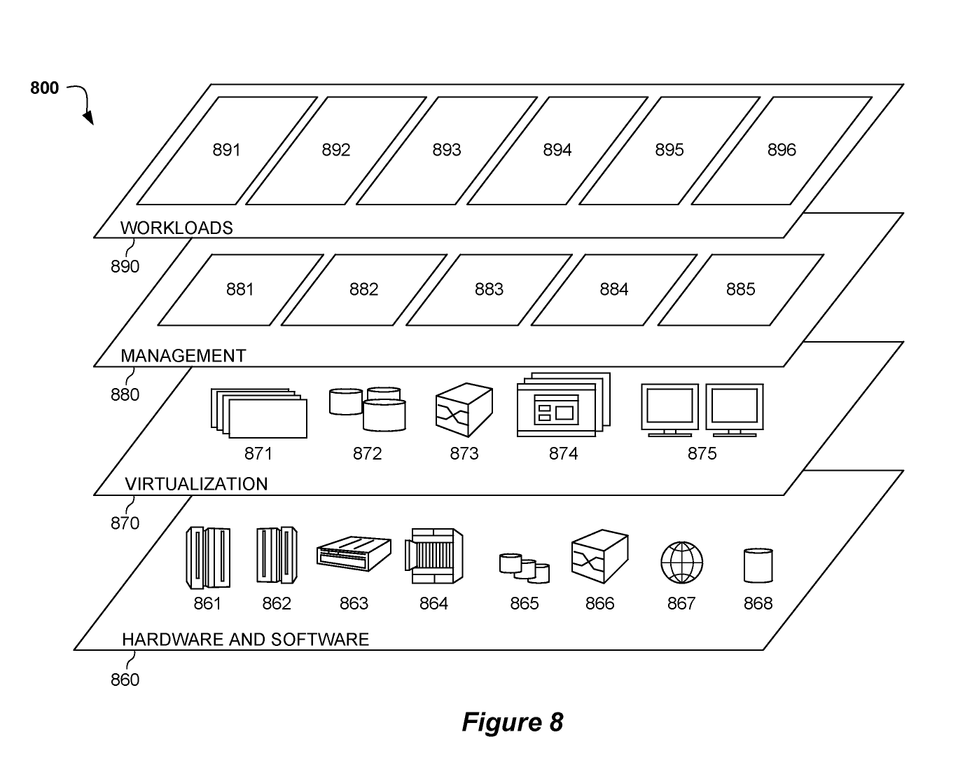

Referring now to FIG. 8, a set of functional abstraction layers 800 provided by cloud computing environment 700 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; virtual classroom education delivery 893; data analytics processing 894; transaction processing 895; and data processing 896. Data processing 896 may relate to storing data and backup data, and retrieving data and backup data.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for processing a set of data files in a storage system,
the storage system comprising one or more compute nodes and a shared file system,
the set of data files stored in at least one of a local storage of the shared file system and a backup storage,
the shared file system controlling access to the set of data files using a first set of first file attributes corresponding to the set of data files,
wherein a first container of a set of containers which are executable on a first compute node of the one or more compute nodes, at least one container of the set of containers comprising a container file system enabling access to a portion of the set of data files in the shared file system assigned to the at least one container of the set of containers using a second set of second file attributes corresponding to the portion of the set of data files,
wherein the first set of first file attributes corresponding to the set of data files comprises a local container path directory address for each data file of the set of data files and are accessible only to the first container of the set of containers,
wherein the second set of second file attributes comprises a shared file system path directory address for each data file of the set of data files, translated from the first set of first file attributes by a container file system adaptor of the storage system,
wherein one or more additional compute nodes each have access to one or more additional portions of the set of data files, wherein the first compute mode does not have access to the one or more additional portions of the set of data files,
wherein the first compute node comprises a first container backup-restore client of a set of BRCs
wherein the first compute node comprises a set of backup clients, wherein each backup client of the set of backup clients corresponds to a container of the set of containers,
the method comprising:
providing the first container a first container backup-restore client (BRC) of a set of BRCs, wherein the first compute node comprises the set of BRCs, wherein each BRC of the set of BRCs correspond to a container of the set of containers which are executable on the first compute node;
providing a first group of one or more backup-restore proxy (BRP) of a set of BRPs, wherein the first compute node comprises the first group of the set of BRPs;
receiving by the first group a data processing request from the first container BRC, the received request comprising the second file attributes of data of the portion of data files to be processed;
sending by the first group the request to a backup client of the storage system, the sent request including the first file attributes of the portion of the data files to be processed; thereby causing the backup client to process the request on at least one of the local storage and backup storage.

2. The method of claim 1, further comprising:
providing a data structure for mapping the first set of first file attributes to the corresponding second set of second file attributes, wherein the sending of the request comprises using the second set of the portion of the data files to be processed for determining the corresponding first set.

3. The method of claim 2, wherein each BRP of the set of BRPs run on a corresponding compute node of the set of BRCs.

4. The method of claim 2, wherein the storage system comprises two or more compute nodes, wherein each compute node of the two or more compute nodes comprises a corresponding backup-restore client (BRP) of the set of BRPs and a corresponding BRP of the set of BRPs, wherein the corresponding BRP sends the data processing request to the corresponding BRP, the corresponding BRP is configured to connect to a remote backup server, the corresponding BRP managing access to the backup storage, the corresponding BRP comprising the data structure.

5. The method of claim 1, wherein the data processing request comprising a backup request for backing up a first subset of data files of the local storage to the backup storage, the data to be processed comprising the first subset of data files, the sending comprising: determining first file attributes of the first subset of the data files corresponding to the second file attributes.

6. The method of claim 5, wherein the determining of the first file attributes of the first subset of the data files comprising sending by the corresponding BRP of the set of BRPs a translation request to the container file system adapter for translating the second file attributes of the first subset of the data files and receiving the first file attributes of the first subset of the data files.

7. The method of claim 5, wherein the sending comprises:
sending by the BRP the backup request to the backup client for controlling the client component to backup the first subset of the data files from the local storage of the shared file system to the backup storage, the backup request comprising both the first and second file attributes of the first subset of the data files.

8. The method of claim 7, wherein the backup client being configured to connect to a backup server, the backup server managing access to the backup storage, the backup server comprising a data structure mapping first file attributes to corresponding second attributes of data files stored on the backup storage, the controlling of the backup client comprising backing up the given data files to the backup server, storing by the backup server the given data files on the backup storage, and updating the data structure to include the first file attributes and corresponding second attributes of the given data files.

9. The method of claim 1, wherein the data processing request comprises:
a restore request for restoring the first subset of the data files from the backup storage to the local storage, the data to be processed comprising the given data files being qualified or indicated by respective second file attributes,
wherein the sending comprising: obtaining the first file attributes of the first subset of the data files, sending the restore request indicating the first file attributes of the first subset of the data files to the backup client for controlling the backup client to restore the given data files from the backup server; receiving from the backup client a result message indicative of the restore request being successfully processed.

10. The method of claim 9, further comprising obtaining the first file attributes of the first subset of the data files comprising:
receiving by the BRP a query request from the BRC, the query request including second file attributes of files that can be queried;
sending by the BRP the query request to the backup client; thereby controlling the backup client to send the query request to a backup server comprising a data structure mapping the second file attributes to the corresponding first file attributes;
receiving from the backup server the first file attributes and the second file attributes, provided by means of the data structure, of the files that can be queried; and
sending to the BRC the first file attributes and the second file attributes of the files that can be queried, causing the BRC to present the received first and second file attributes to a user of the storage system and to receive a selection of the given data files.

11. The method of claim 5, the container file system adapter comprising a data structure for translating the second file attributes, the data structure mapping the first file attributes to the corresponding second file attributes.

12. The method of claim 1, the shared file system comprising the backup client, wherein the backup client is configured to connect to a remote backup server, the backup server managing access to the backup storage.

13. The method of claim 1, the BRC being a thin client that is configured to send the data processing request as a HTTP request to the BRP.

14. The method of claim 1, the storage system comprising a second compute node running a second container enabling access to a respective distinct other portion of the data files in the shared file system assigned to the second container using respective second file attributes of the first subset of the of the data files, the method further comprising: determining that at least one file of the first subset of the data files to be processed has a dependency with a second subset of the data files of the second container controlling the BRP to send a request to the shared file system, indicating at least one of the first and second file attribute of the second subset of the data file in order to be processed in a similar manner as the data to be processed of the first subset of the data file.

15. The method of claim 14, wherein the determining of the dependency is performed using dependency data, wherein the dependency data indicates at least one of: content dependency between the first subset and the second subset of the storage system, owners of the files of the storage system.

16. The method of claim 1, wherein a file attribute of the first and second file attributes comprises at least one of a respective file path, file type and file name.

17. A computer program product for processing a set of data files in a storage system,
the storage system comprising one or more one compute nodes and a shared file system, the set of data files stored in at least one of a local storage of the shared file system and a backup storage, the shared file system controlling access to the set of data files using a first set of first file attributes corresponding to the set of data files,
wherein a first container of a set of containers which are executable on a first compute node of the one or more compute nodes, at least one container of the set of containers comprising a container file system enabling access to a portion of the set of data files in the shared file system assigned to the at least one container of the set of containers using a second set of second file attributes corresponding to the portion of the set of data files,
wherein the first set of first file attributes corresponding to the set of data files comprises a local container path directory address for each data file of the set of data files and are accessible only to the first container of the set of containers,
wherein the second set of second file attributes comprises a shared file system path directory address for each data file of the set of data files, translated from the first set of first file attributes by a container file system adaptor of the storage system,
wherein one or more additional compute nodes each have access to one or more additional portions of the set of data files, wherein the first compute mode does not have access to the one or more additional portions of the set of data files,
wherein the first compute node comprises a first container backup-restore client of a set of BRCs,
wherein the first compute node comprises a set of backup clients, wherein each backup client of the set of backup clients corresponds to a container of the set of containers,
the computer program product comprising:
one or more computer-readable tangible storage medium and program instructions stored on at least one of the one or more tangible storage medium, the program instructions executable by a processor, the program instructions comprising:
program instructions to provide the first container a first container backup-restore client (BRC) of a set of BRCs, wherein the first compute node comprises the set of BRCs, wherein each BRC of the set of BRCs correspond to a container of the set of containers which are executable on the first compute node;
program instructions to provide a first group of one or more backup-restore proxy (BRP) of a set of BRPs, wherein the first compute node comprises the first group of the set of BRPs;
program instructions to receive by the first group a data processing request from the first container BRC, the received request comprising the second file attributes of data of the portion of data files to be processed;
program instructions to send by the first group the request to a backup client of the storage system, the sent request including the first file attributes of the portion of the data files to be processed; thereby causing the backup client to process the request on at least one of the local storage and backup storage.

18. A backup-restore system being configured for:
receiving a data processing request from a backup-restore client, BRC of a first container of a set of containers, the request indicating second file attributes of data to be processed, wherein the second file attributes are configured to enable access to data files by the container,
wherein a first set of first file attributes corresponding to the set of data files comprises a local container path directory address for each data file of the set of data files and are accessible only to the first container,
wherein the second set of second file attributes comprises a shared file system path directory address for each data file of the set of data files, translated from the first set of first file attributes by a container file system adaptor of the storage system;
determining first file attributes corresponding to the second file attributes, wherein the first file attributes are configured to control access to data file by a shared file system;
sending the request to a backup client of the storage system, the sent data request indicating the second file attributes of the data to be processed; thereby causing the backup client to process the request on the local storage and/or backup storage.

19. The backup-restore system according to claim 18, further comprising:
at least one compute node and a shared file system, the data files being stored in at least one of a local storage and a backup storage, the shared file system controlling access to the data files using first file attributes, wherein at least one container is executable on the compute node, the container comprising a container file system enabling access to a portion of the data files assigned to the container using second file attributes.
